(19) United States
(12) Patent Application Publication
(10) Pub. No.: US 2026/0296585 A1
(43) Pub. Date: Oct. 1, 2026

(54) MOTORCYCLE SEAT LOCK

(71) Applicant: Frank Semans, Aurora, CO (US)

(72) Inventor: Frank Semans, Aurora, CO (US)

(21) Appl. No.: 19/096,861

(22) Filed: Apr. 1, 2025

(51) Int. Cl. B62H 5/00; B62J 1/12; B62J 1/28

(52) U.S. Cl. CPC B62H 5/006; B62J 1/12; B62J 1/28

(57) ABSTRACT

A motorcycle seat lock includes a base panel, a cover panel, and a lock. The base panel includes a base orifice for passage of a seat bolt through the base panel, which seat bolt is passed through a seat bracket projecting from a motorcycle seat and into a receptacle of a motorcycle body to secure the seat bracket and the motorcycle seat to the motorcycle body. The cover panel is pivotably coupled to the base panel. The cover panel is selectively pivotable between an open position pivoted away from the base panel and a closed position stacked above the base panel and covering the seat bolt. The lock is mounted on the cover panel. The lock includes a lock tab that is rotatable to engage with the base panel to releasably lock the cover panel in the closed position on the base panel with the seat bracket in between.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to motorcycle security devices and more particularly pertains to a new motorcycle seat lock for locking a motorcycle seat in place against theft. Motorcycle seats are valuable components of motorcycles and can be quite expensive, and thus could be targets for theft. Unfortunately, motorcycle seats are held in place by a single threaded bolt inserted through a seat bracket and into a threaded receptacle in the motorcycle body, which threaded bolt can be relatively easily removed. The new motorcycle seat lock covers the threaded bolt to prevent removal and thus prevent theft of the motorcycle seat.

### (2) Description of Related Art Including Information Disclosed Under 37 CFR 1.97 and 1.98

The prior art relates to motorcycle anti-theft devices. The prior art, as best understood, does not disclose a motorcycle seat lock that includes a base panel, a cover panel, and a lock. The cover panel is selectively pivotable between an open position pivoted away from the base panel and a closed position stacked above the base panel and covering a seat bolt holding the motorcycle seat in place. The lock is mounted on the cover panel. The lock includes a lock tab that is rotatable to engage with the base panel to releasably lock the cover panel in the closed position on the base panel with the seat bracket in between.

### (h) BRIEF SUMMARY OF THE INVENTION

An embodiment of the disclosure meets the needs presented above in a motorcycle seat lock generally comprising a base panel, a cover panel, and a lock. The base panel includes a base orifice for passage of a seat bolt through the base panel, which seat bolt is passed through a seat bracket projecting from a motorcycle seat and into a receptacle of a motorcycle body to secure the seat bracket and the motorcycle seat to the motorcycle body. The cover panel is pivotably coupled to the base panel. The cover panel is selectively pivotable between an open position pivoted away from the base panel and a closed position stacked above the base panel and covering the seat bolt. The lock is mounted on the cover panel. The lock includes a lock tab that is rotatable to engage with the base panel to releasably lock the cover panel in the closed position on the base panel with the seat bracket in between.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a motorcycle seat lock according to an embodiment of the disclosure.

FIG. 2 is a perspective view of an embodiment of the disclosure.

FIG. 3 is a top view of an embodiment of the disclosure.

FIG. 4 is a side view of an embodiment of the disclosure in use.

FIG. 5 is a side view of an embodiment of the disclosure in use.

FIG. 6 is a side view of an embodiment of the disclosure in use.

FIG. 7 is a top view of an embodiment of the disclosure in use.

### (j) DETAILED DESCRIPTION OF THE INVENTION

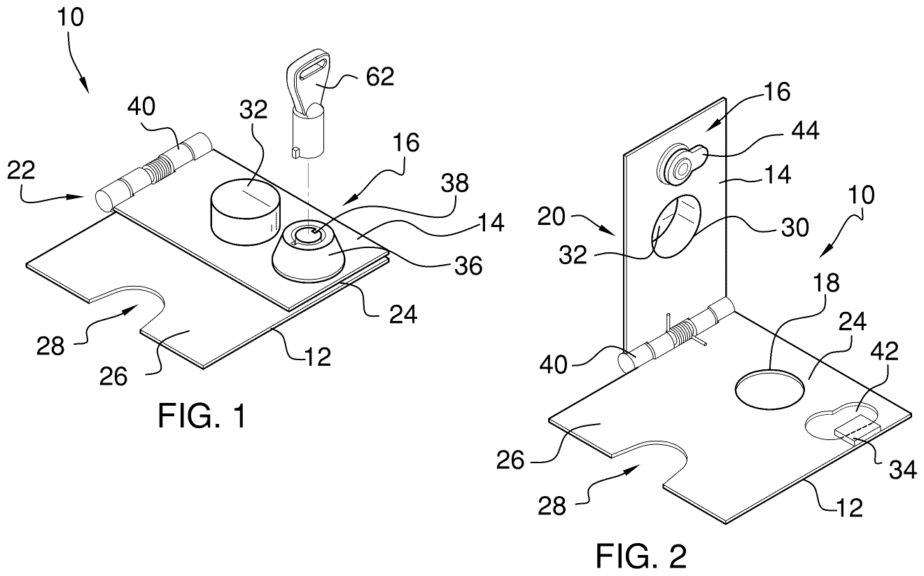

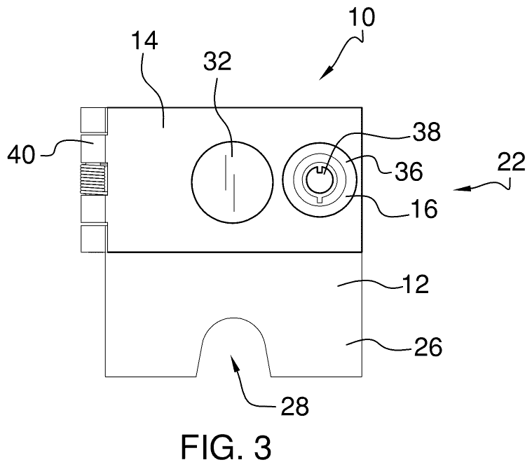

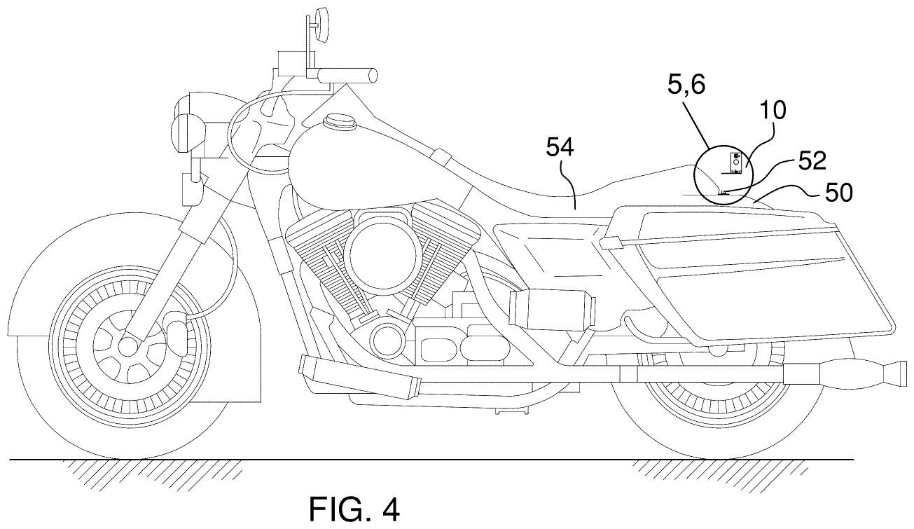

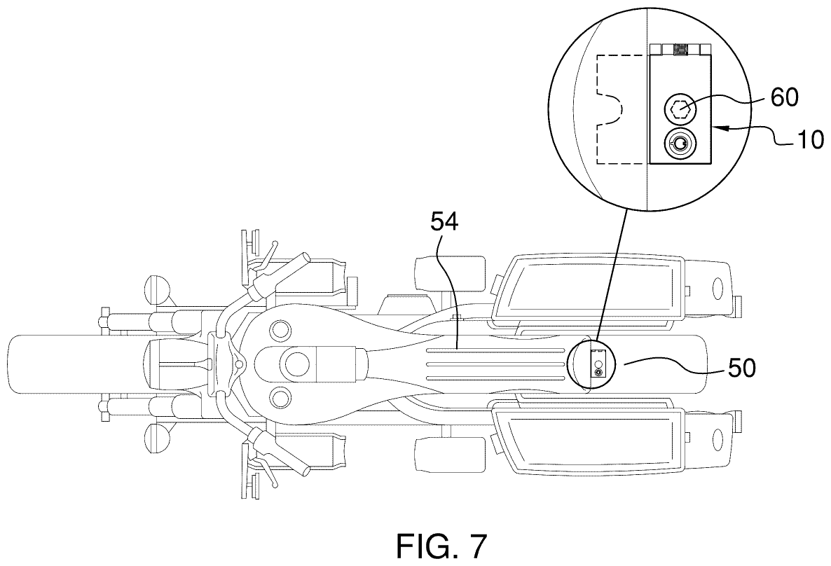

With reference now to the drawings, and in particular to FIGS. 1 through 7 thereof, a new motorcycle seat lock embodying the principles and concepts of an embodiment of the disclosure and generally designated by the reference numeral 10 will be described.

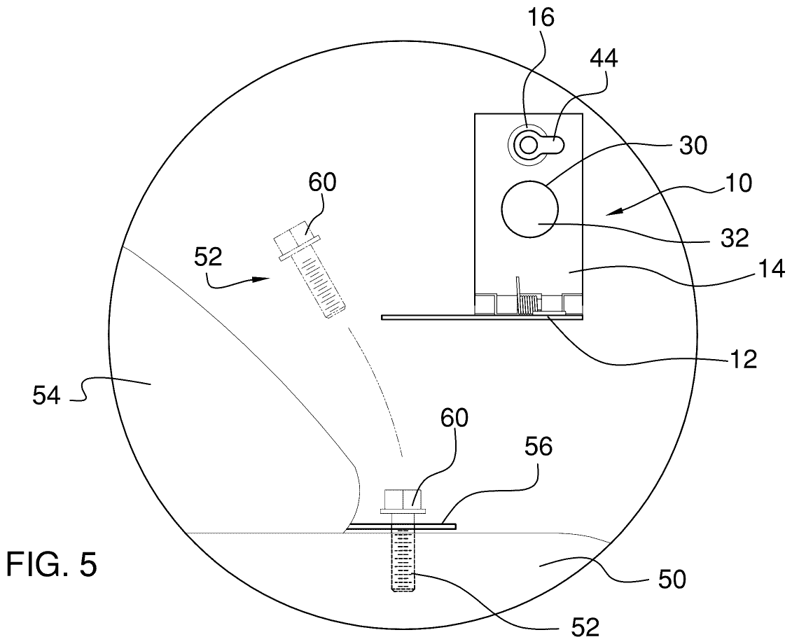

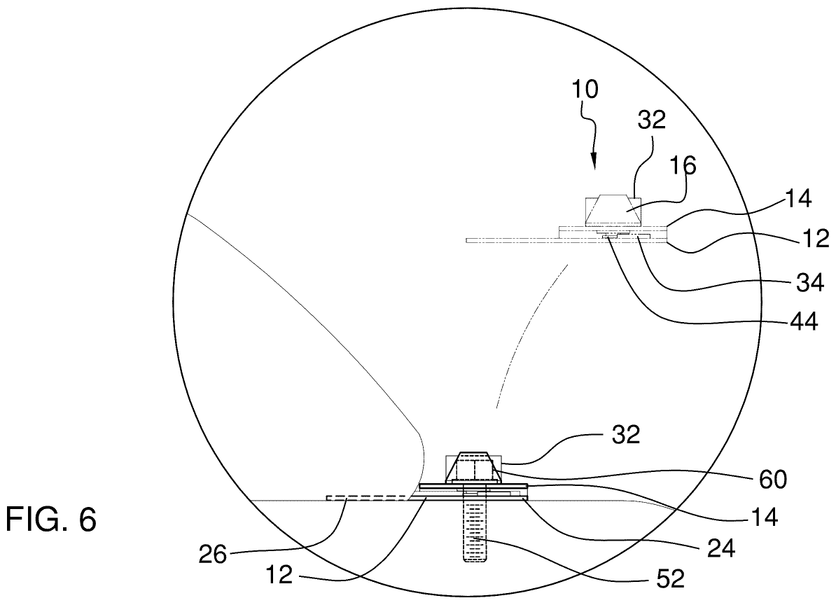

As best illustrated in FIGS. 1 through 7, the motorcycle seat lock 10 generally comprises a base panel 12, a cover panel 14, and a lock 16. The base panel 12 includes a base orifice 18 for passage of a seat bolt 52 through the base panel 12, which seat bolt 52, as shown in FIGS. 5 and 6, is passed through a seat bracket 56 projecting from a motorcycle seat 54 and into a threaded receptacle 58 of a motorcycle body 50 to secure the seat bracket 56 and the motorcycle seat 54 to the motorcycle body 50. The cover panel 14 is pivotably coupled to the base panel 12. As shown in FIGS. 1 and 2, the cover panel 14 is selectively pivotable between an open position 20 pivoted away from the base panel 12 and a closed position 22 stacked above the base panel 12 and covering the seat bolt 52. The lock 16 is mounted on the cover panel 14. The lock 16 includes a lock tab 44 that is rotatable to engage with the base panel 12 to releasably lock the cover panel 14 in the closed position 22 on the base panel 12 with the seat bracket 56 in between.

In the exemplary embodiment in FIGS. 1 and 2, the base panel 12 includes a main portion 24 and an extension portion 26. The cover panel 14 overlaps the main portion 24 in the closed position 22. The extension portion 26 is designed to be inserted under the motorcycle seat 54, as shown in FIG. 6. As shown in FIGS. 1 through 3, the extension portion 26 includes a recess 28 designed to fit around a portion of the motorcycle seat 54.

In the exemplary embodiment in the figures, the cover panel 14 includes a cover orifice 30 for passage of a head 60 of the seat bolt 52 through the cover panel 14. The cover panel 14 includes a cover projection 32 over the cover orifice 30. The cover projection 32 is designed to receive and cover the head 60 of the seat bolt 52 when the cover panel 14 is in the closed position 22. It should be noted that the cover projection 32 is only one possible design. For example, the cover panel 14 could have bent sections such that there is a raised section in the middle to cover the head 60 of the seat bolt 52.

In the exemplary embodiment in FIG. 2, the base panel 12 includes a lock receptacle 34 designed to receive the lock tab 44 after rotation. After closing the cover panel 14, the lock tab 44 can be rotated into the lock receptacle 34. An optional lock orifice 42 could be included in the base panel 12 to provide space for the lock tab 44. The lock 16 is a barrel lock. The barrel lock includes a shell 36 and a plug 38 projecting from the cover panel 14. It should be noted that the barrel lock with the lock tab 44 and the lock receptacle 34 is only one exemplary embodiment. Other locking mechanisms, such as a padlock or a wire lock, could be used.

The motorcycle seat lock 10 includes a hinge 40 connecting the base panel 12 and the cover panel 14. The hinge 40 could be spring-loaded in one possible embodiment.

The motorcycle seat lock 10 is used to cover the seat bolt 52 to prevent removal of the motorcycle seat 54 from the motorcycle body 50. The seat bolt 52, if installed, is first removed by unscrewing from the threaded receptacle 58, as shown in FIG. 5. The extension portion 26 of the base panel 12 is inserted under the motorcycle seat 54, with the main portion 24 of the base panel 12 under the seat bracket 56. The seat bolt 52 is then inserted through the seat bracket 56 and the base orifice 18 and into the threaded receptacle 58. The cover panel 14 is then pivoted down over the base panel 12. A user then uses a key 62 to engage the lock 16 and lock the cover panel 14 over the seat bolt 52 to prevent removal. In the exemplary embodiment, the lock tab 44 is rotated into the lock receptacle 34 to lock the cover panel 14 to the base panel 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A motorcycle seat lock comprising:
a base panel, the base panel including a base orifice for passage of a seat bolt through the base panel, which seat bolt is passed through a seat bracket projecting from a motorcycle seat and into a receptacle of a motorcycle body to secure the seat bracket and the motorcycle seat to the motorcycle body;
a cover panel, the cover panel being pivotably coupled to the base panel, the cover panel being selectively pivotable between an open position pivoted away from the base panel and a closed position stacked above the base panel and covering the seat bolt; and
a lock, the lock being mounted on the cover panel, the lock including a lock tab being rotatable to engage with the base panel to releasably lock the cover panel in the closed position on the base panel with the seat bracket in between.

2. The motorcycle seat lock of claim 1, wherein:
the base panel includes a main portion and an extension portion;
the cover panel overlaps the main portion in the closed position; and
the extension portion is configured to be inserted under the motorcycle seat.

3. The motorcycle seat lock of claim 2, wherein the extension portion includes a recess configured to fit around a portion of the motorcycle seat.

4. The motorcycle seat lock of claim 1, wherein:
the cover panel includes a cover orifice for passage of a head of the seat bolt through the cover panel;
the cover panel includes a cover projection over the cover orifice; and
the cover projection is configured to receive and cover the head of the seat bolt when the cover panel is in the closed position.

5. The motorcycle seat lock of claim 1, wherein the base panel includes a lock receptacle configured to receive the lock tab after rotation.

6. The motorcycle seat lock of claim 1, further including a hinge connecting the base panel and the cover panel.

7. The motorcycle seat lock of claim 1, wherein:
the lock is a barrel lock; and
the barrel lock includes a shell and a plug projecting from the cover panel.

8. The motorcycle seat lock of claim 3, wherein:
the cover panel includes a cover orifice for passage of a head of the seat bolt through the cover panel;
the cover panel includes a cover projection over the cover orifice; and
the cover projection is configured to receive and cover the head of the seat bolt when the cover panel is in the closed position.

9. The motorcycle seat lock of claim 8, wherein the base panel includes a lock receptacle configured to receive the lock tab after rotation.

10. The motorcycle seat lock of claim 9, further including a hinge connecting the base panel and the cover panel.

11. The motorcycle seat lock of claim 10, wherein:
the lock is a barrel lock; and
the barrel lock includes a shell and a plug projecting from the cover panel.
